(19) United States
(12) Patent Application Publication
(10) Pub. No.: US 2016/0160324 A1
(43) Pub. Date: Jun. 9, 2016

(54) A ROTARY ENGINE

(71) Applicant: ORBITAL POWER LTD, LONDON (GB)

(72) Inventor: SHAWN OKUN, PALM HARBOUR, FL (US)

(21) Appl. No.: 14/909,260

(22) PCT Filed: Aug. 1, 2014
(86) PCT No.: PCT/GB2014/052374

§ 371 Date: Feb. 1, 2016

(30) Foreign Application Priority Data
Aug. 1, 2013 (GB) 1313824.3

(51) Int. Cl. C22C 32/00; F02B 55/08; C22C 21/00; F02B 55/02

(52) U.S. Cl. CPC C22C 32/0063; F02B 55/02; F02B 55/08; C22C 21/00

(57) ABSTRACT

A rotary engine (10, 510) with improved cooling, and a MMC material for a rotary engine are provided. The rotary engine (10, 510), comprises a rotor (20, 520) having an interior and an exterior divided by a plurality of rotor faces (68, 568), a rotor chamber housing assembly (14, 514) surrounding the rotor exterior, and a side plate (16, 516) coupled to the rotor chamber housing assembly (14, 514). The side plate (16, 516) comprises a charge air inlet (34, 514) port arranged to direct charge air to the interior of the rotor (20, 520) and a charge air exit port (48, 548). The charge air exit port (48, 548) is intermittently exposable by the rotor faces (68, 568) to selectively exhaust charge air from the rotor interior directly to the chamber housing assembly (14, 514), for combustion, depending on the rotational position of the rotor (20, 520).

The present invention relates to improvements in rotary engines, to materials for fabricating rotating components of an engine, particularly rotary engines such as a Wankel engine or the like, in order to provide self lubricating properties during use, to cooling of rotary engines and to rotary engine design for ready assembly.

A typical rotary engine has a rotor housing assembly defining a rotor chamber and a rotor chamber housing. A rotatable shaft is journalled through the rotor housing assembly. The rotatable shaft is coupled to a rotor situated within the rotor chamber housing assembly. Depending on the shape of the rotor, the rotor has three apex seals arranged to selectively contact the rotor chamber housing assembly during revolution in order to form a hermetic seal. When in contact, the apex seal and the rotor chamber housing act as friction surfaces and require lubrication.

One known method of lubricating the friction surfaces is to admix a lubricant to the fuel. Such a method is not particularly effective.

GB1347819 ('819) describes a known rotary engine using lubricant admixed to fuel. Because of problems with such a system, '819 advocates the use of a modified sintered alloy for producing the apex seals in order to provide self lubrication and thus remove the need for admixing a lubricant to the fuel. The apex seals are also said to have the advantage of improved abrasion resistance. '819 goes on to explain that such abrasion resistance allows the use of a chromium plated rotor chamber housing assembly rather than using a nickel and silicon carbide plated rotor chamber housing assembly, which are said to be associated with very high production costs.

It is an object of the present invention to provide a rotary engine having improved lubricating properties. It is a further object of the invention to provide improved materials for use in the manufacture of internal combustion engines, particularly those of the reciprocating piston type and of the rotary type, more particularly rotary Wankel engines.

According to a first aspect of the present invention there is provided one or more engine components selected from the list of a rotary engine rotor chamber housing, a rotary engine rotor chamber housing assembly, a rotary engine rotor, a piston, a side plate, and a shaft, made from a Metal Matrix Composite (MMC) material comprising; 10-35% (wt) silicon carbide; 1-10% (wt) nickel coated graphite; and a balance of aluminium.

This mix of constituent materials exhibit self lubricating properties over a wide range of operating temperatures. The temperature range is from about −40° C. to a temperature at which material deformation occurs. The nickel coated graphite exhibits self lubricating properties between about −40° C. and 100° C. At higher temperatures between 85° C. to material deformation the silicon carbide provides the self lubricating properties. The upper temperature limit is intended to include the maximum temperature envisaged for an engine in use. Those components together with the components contacting therewith experience a prolonged life cycle as a result of the improved lubriciousness of the material. Also, this mix of constituent materials improves the ease at which those rotary engine components can be worked during fabrication.

The metal matrix composite (MMC) material preferably comprises a quantity of silicon carbide from 15-30% (wt). More silicon carbide results in improved lubriciousness of the material. Above 30% (wt) the material becomes more difficult to mold. Therefore, 30% (wt) silicon carbide is considered to be the preferred upper limit, although circumstances may permit up to 35% (wt) silicon carbide.

The metal matrix composite material may comprise a quantity of nickel coated graphite from 5-7.5% (wt). This range of nickel coated graphite is sufficient because lubriciousness in the lower temperature range improves with increased quantities of nickel coated graphite. The improvements in lubriciousness begin to diminish above 7.5% (wt) nickel coated graphite so this is considered to be the maximum preferred quantity without significantly increasing cost of the material.

The MMC material may further comprise 0.2-3% (wt) magnesium. The magnesium adds strength to the mix. The magnesium also improves cohesiveness between the constituents of the mix. This specific range of magnesium is sufficient to achieve those characteristics when used with the aforementioned ranges of silicon carbide and nickel coated graphite.

Where the engine component is the rotor, the MMC material may further comprise 9-20% (wt) silicon. Silicon improves the thermal conductivity of the material. The range of 9-20% (wt) silicon provides a material having thermal conductivity properties similar to tempered steel as opposed to pure aluminium. This is particularly advantageous for the rotor which experiences rapid changes in temperature during operation. The range of silicon may be 9-15% (wt). This range is considered to be sufficient in most circumstances. A quantity of Silicon of 11% (wt) is a typical quantity for use with an eccentric shaft of a rotary engine. In one embodiment of the invention, the engine component is a rotary engine rotor made from a metal matrix composite material comprising 10-35% (wt) silicon carbide, 1-10% (wt) nickel coated graphite, 0.2-3% (wt) magnesium, 9-20% (wt) silicon and the balance aluminium.

Where the engine component is the shaft, the MMC material may further comprise 0.18 to 0.22% (wt) Scandium. Scandium improves wear resistance in aluminium from heat. In another embodiment, the engine component comprises an eccentric shaft of a rotary engine (E-Shaft) made from a metal matrix composite material comprising 10-35% (WT) silicon carbide, 1-10% (wt) nickel coated graphite, 0.2-3% (wt) magnesium, 0.18-0.22% (wt) Scandium and the balance aluminium. Preferably the E-shaft MMC material further comprises 9-20% (wt) silicon.

According to a second aspect of the present invention there is provided, a Metal Matrix Composite (MMC) material for use with an engine component comprising 10-35% (wt) silicon carbide, 1-10% (wt) nickel coated graphite, and a balance of aluminium.

The MMC may be beneficial for use with engine components for all types of engines, where lubrication is important.

The quantity of silicon carbide may be from 15 to 30% (wt).

More silicon carbide results in improved lubriciousness of the material. Above 30% (wt) the material starts to become more difficult to mold. Therefore, 30% (wt) silicon carbide is considered to be the preferred upper limit, although circumstances may permit up to 35% (wt) silicon carbide.

The quantity of nickel coated graphite may be from 5 to 7.5% (wt).

This range of nickel coated graphite is sufficient because lubriciousness in the lower temperature range improves with increased quantities of nickel coated graphite. The improvements in lubriciousness diminish above 7.5% (wt) nickel coated graphite so this is considered to be the maximum preferred quantity without significantly increasing cost of the material.

The MMC material may preferably further comprise 0.2-3% (wt) Magnesium.

The magnesium adds strength to the mix. The magnesium also improves cohesiveness between the constituents of the mix. This specific range of magnesium is sufficient to achieve those characteristics when used with the aforementioned ranges of silicon carbide and nickel coated graphite.

The engine component is preferably selected from the list of a rotor, a piston, a side plate, a rotor chamber housing or housing assembly, and a shaft.

Those engine components require lubrication on at least one surface since they interface with other components during operation. Those components therefore benefit most from being made from the MMC material.

The engine components are preferably rotary engine components.

Rotary engines are typically difficult to lubricate since they are enclosed assemblies making access to the friction surfaces of those components difficult for lubricating.

The engine component is preferably the rotor further comprising 9-20% (wt) Silicon.

Silicon improves the thermal conductivity of the material. The range of 9-20% (wt) silicon provides a material having thermal conductivity properties similar to tempered steel as opposed to pure aluminium. This is particularly advantageous for the rotor which experiences rapid changes in temperature during operation.

The range of Silicon may be from 9 to 15% (wt). This range is considered to be sufficient in most circumstances. A quantity of Silicon of 11% (wt) is a typical quantity for use with an eccentric shaft of a rotary engine.

The engine component is preferably an eccentric shaft of a rotary engine and the material further comprises 0.18-0.22% (wt) of Scandium.

According to a third aspect of the present invention there is provided a rotary engine comprising one or more of the aforementioned engine components comprising the aforementioned MMC material. The MMC material is particularly applicable to those components since those components require lubrication due to the friction forces they experience during operation of the engine.

Rotary engines, such as a Wankel engine or the like, comprise a housing assembly having an epitrochoid chamber housing assembly. Broadly speaking, the chamber housing assembly is divided into four segments of varying volume by a rotating rotor having three faces. Those segments include a charge air intake segment, a compression segment, a combustion segment and an exhaust segment. In this sense the term “charge air” is defined as ambient air. Charge air can be premixed with fuel vapour for combustion using a carburettor upstream of the engine. The charge air intake segment has an intake port and the exhaust segment has an exhaust port. The combustion segment is coupled to an ignition means such as a spark plug. An eccentric shaft, or e-shaft, is journalled through the sides of the housing assembly and is meshed to the rotor so that rotor rotation induces rotation of the e-shaft. The three rotor faces form three lobes each comprising an apex seal. The apex seals are designed to be in contact with the chamber housing assembly during revolution of the rotor. The apex seals co-operate with the rotor chamber housing assembly to hermetically isolate adjacent chamber housing assembly segments. Each rotor face moves sequentially through each segment. The charge air temperature within each segment varies greatly. For example the charge air temperature in the intake segment is relatively low and the temperature in the combustion segment is relatively high.

Accordingly, rotary engines have problems caused by such temperature imbalance. Attempts have been made to provide an engine cooling system for cooling the rotor, particularly during the combustion segment. Such engine cooling systems require a coolant to contact the rotor. This is difficult since the rotor is encased within the rotor chamber housing assembly making accessibility difficult.

One such cooling system uses oil fed into the rotor interior from one side of the housing assembly. The oil then conducts heat away from the posterior face of each rotor face. However, oil based systems are often complex, expensive and heavy.

It is also known to use charge air to cool the rotor. A known rotary engine of this type has an inlet port and an exit port on opposing sides of the housing assembly in the vicinity of the eccentric shaft. The inlet port and the exit port are fluidly communicable due to a set of radial spokes used for supporting the rotor faces about the shaft thus allowing passage of air from one side of the rotor interior to the other. The charge air passes through to the rotor interior through the inlet on one side and out from the rotor interior through exit port on the other side. A duct carries the charge air from the exit port to the charge air intake port on the rotor chamber housing assembly for combustion. Such a system is not particularly effective at cooling the anterior surface of each rotor face since the charge air passes straight through the interior of the rotor from one side plate to the other relatively quickly and without sufficient radial dispersement to the anterior surfaces of the rotor faces in order to conduct away heat.

It is an object of a fourth aspect of the present invention to provide a rotary engine having an improved cooling means which addresses the aforementioned problems.

According to the fourth aspect of the present invention there is provided a rotary engine, comprising a rotor having an interior and an exterior divided by a plurality of rotor faces, a rotor chamber housing assembly surrounding the rotor exterior, a side plate coupled to the rotor chamber housing assembly, the side plate comprising a charge air inlet port arranged to direct charge air to the interior of the rotor and a charge air exit being port intermittently exposable by the rotor faces to selectively exhaust charge air from the rotor interior directly to the chamber housing assembly, for combustion, depending on the rotational position of the rotor.

Charge air is defined as ambient air regardless as to whether or not it includes fuel vapour. Only allowing charge air to exit the rotor interior intermittently results in the charge air remaining in the rotor interior for a longer period compared to directing charge air from one side of the rotor to the other. The increased time the charge air remains in the rotor interior results in an increased exposure time to the rotor faces thus drawing more heat away in turn. Also, rotation of the rotor circulates the charge air causing radial dispersement due to induce centrifugal motion of the rotor causing further increases in charge air contacting the rotor.

The side plate may further comprise a channel connecting the inlet and exit ports and having an edge defining an opening being substantially fluidly contained within the rotor interior by a set of side seals, arranged at the edges of the rotor faces being in continuous contact with the side plate. Rotation of the rotor further enhances charge air circulation at the rotor interior causing an increase charge air volume contacting the rotor face.

The exit and inlet ports are preferably angularly separated by 120 to 240°. The exit and inlet ports are preferably angularly separated by 120 to 180°. Separating the exit and inlet ports in this way maximises the chance of the charge air circulating within the rotor interior rather than going directly to the rotor chamber housing assembly through the exit port.

The opening of the channel is preferably substantially oculiform. During revolution of the rotor an imaginary boundary is formed on the side plate which the rotor faces never pass. The area inside the boundary is always at the rotor interior regardless of the orientation of the rotor. For a trilobal, or three face rotor, such a boundary is in the shape of an oculiform. Forming the opening of the chamber housing assembly to have the profile of the oculiform boundary increases the effectiveness of the charge air to be dispersed radially.

The channel preferably extend radially out from the opening. The channel preferably comprises a substantially annular section.

The channel preferably comprises a plurality of flow deflectors arranged to direct flow radially outwards. The flow deflectors further optimise the effectiveness of the channel to radially disperse the charge air.

The flow deflectors are preferably continuous. The flow deflectors are preferably substantially arcuate. The flow deflectors preferably comprise ribs. Alternatively, the flow deflectors preferably comprise grooves.

The side plate is preferably a first side plate and the rotary engine may further comprise an opposing second side plate. The second side plate preferably also comprises a charge air inlet port, a charge air exit port and a channel, all arranged to substantially form a mirror image of the charge air inlet port, the charge air exit port and the channel of the first side plate. Introducing charge air to both sides of the rotor provides more balanced cooling of the rotor.

The rotor interior preferably further comprises a radial web arranged to divide the rotor interior into two charge air flow compartments. The radial web provides and additional means of encouraging radial disbursement of the charge air same response to rotation of the rotor.

The radial web is preferably substantially central. A substantially centrally located radial web further enhances the balance in cooling across the rotor.

The rotary engine preferably further comprises a manifold arranged to supply charge air to both charge air inlet ports. The manifolds allows for a central reservoir of charge air to be used.

The manifold preferably comprises a bifurcated duct fluidly connected to both inlet ports.

The manifold is preferably substantially centrally located adjacent to the engine.

The charge air preferably comprises fuel vapour injected upstream of the engine. As the charge air travels through the air cooling system, the fuel vapour further improves the cooling of the rotor faces since the latent heat is extracted when the fuel further vaporises. Furthermore, the vaporised fuel ignites better so improves the combustion performance of the engine.

The charge air preferably further comprises a fuel injection system for injecting fuel vapour into the charge air stream in the intake segment of the chamber housing assembly. This allows for an increased degree of control over the location of where the fuel vapour is injected into the engine and when.

It is an object of a fifth aspect of the present invention to provide a rotary engine with improved maintainability.

Known rotary engines comprise a rotor contained within a housing assembly. One of the major drawbacks of rotary engines is the maintenance burden of having a complex rotating part sealed within the enclosed housing assembly.

According to the fifth aspect of the present invention there is provided a rotary engine rotor housing assembly comprising a first side plate coupled to a first side of a rotor chamber housing assembly, the first side plate having an aperture arranged to receive a fixed shaft therethrough, a second side plate coupled to a second side of the rotor chamber housing assembly, the interior of the rotor chamber housing assembly being accessible for maintenance by removal of the second side plate.

Previous rotary engine assemblies had two housing assembly parts which encased the rotor. Such assemblies required both parts to be taken off the shaft and the shaft to be decoupled when the rotor requires servicing. This new assembly allows the rotor to be accessed by removing a single housing assembly component, ie the second side plate, and allows the remaining housing assembly components to remain assembled about the shaft without the need to decouple the shaft.

The second side plate preferably comprises a plurality of through holes alignable with a plurality of internally threaded holes on the second side of the rotor chamber housing assembly, the rotor housing assembly further comprising a plurality of threaded fasteners arranged to connect the second side plate to the second side of the rotor chamber housing.

The fasteners each preferably comprise a bolt.

The first side plate preferably comprises a plurality of through holes alignable with a plurality of internally threaded holes on the first side of the chamber housing, the rotor housing assembly further comprising an additional plurality of fasteners arranged to connect the second side plate to the second side of the chamber housing assembly.

The additional fasteners each preferably comprises a bolt.

The internally threaded holes on the first and second sides of the rotor chamber housing assembly are preferably not linked.

The rotor housing assembly preferably further comprises a guide for locating the second side plate on the second side of the rotor chamber housing assembly such that the through holes thereof are aligned with the internally threaded holes of the second side of the chamber housing assembly.

The guide preferably comprises a through hole in the first side plate, a through hole in the second side plate and a through hole in the rotor chamber housing assembly and an elongate member arranged to pass entirely therethrough.

The guide preferably comprises a second through hole in the first side plate, a second through hole in the second side plate and a through hole in the rotor chamber housing assembly and a second elongate member arranged to pass entirely therethrough.

The first and second elongate members each preferably comprises a relatively long bolt.

Examples of the present invention are described below in detail with reference to the accompanying drawings, of which:

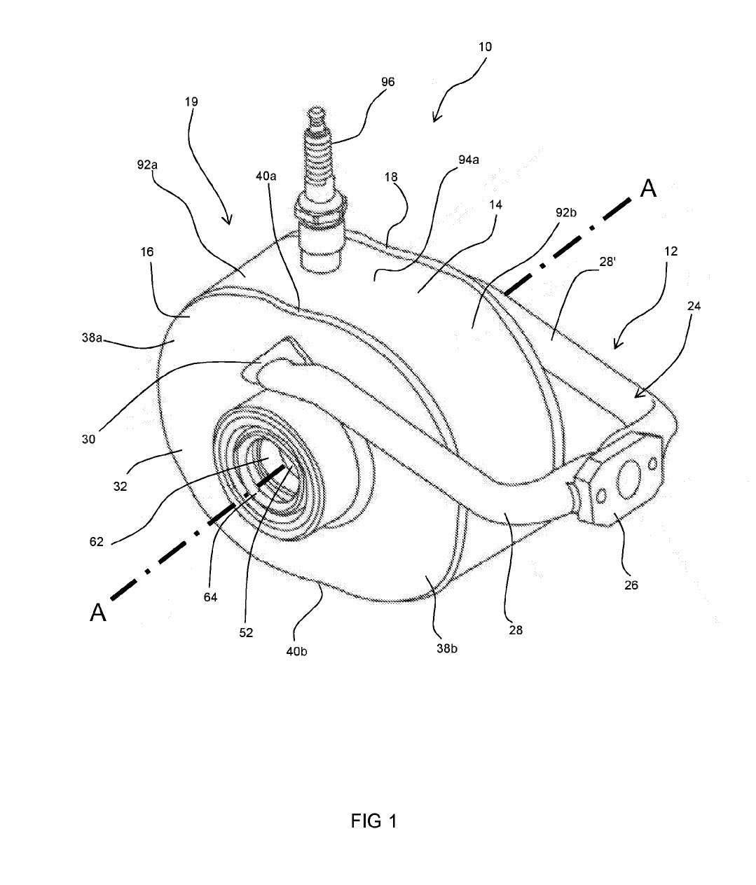

FIG. 1 shows a perspective view of a rotary engine according to one embodiment of the present invention;

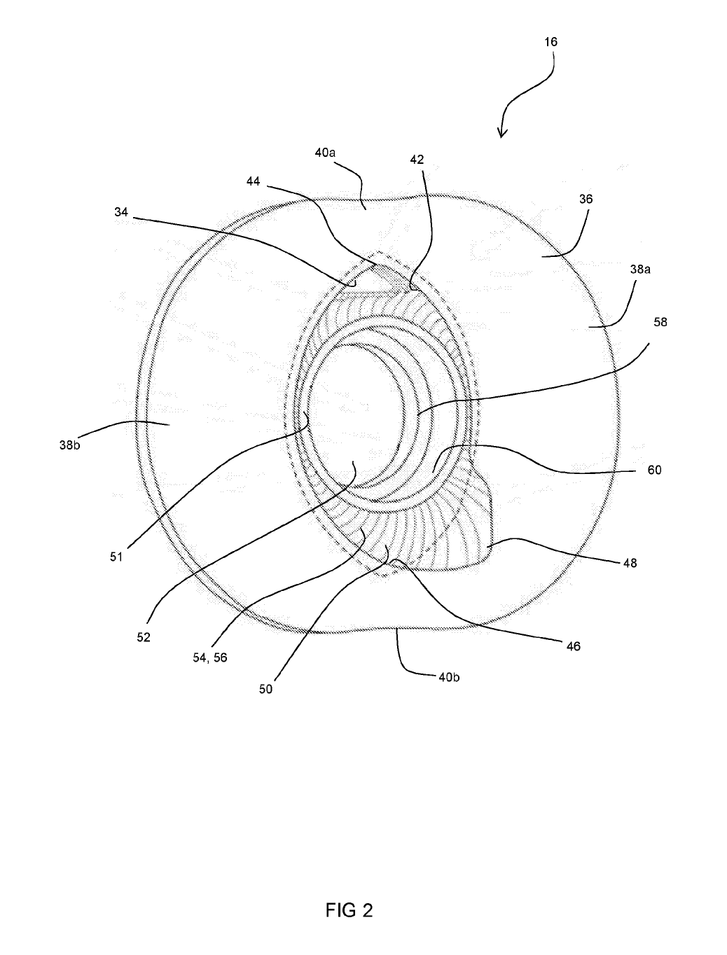

FIG. 2 show a perspective view of a side plate of the rotary engine of FIG. 1 looking from the inside of the engine;

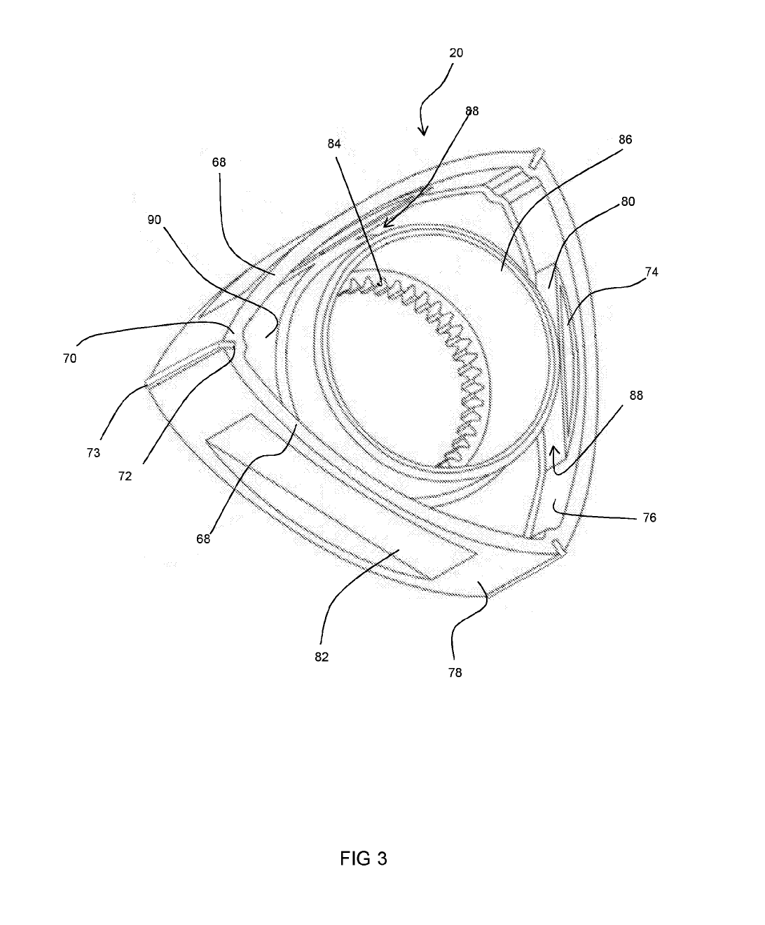

FIG. 3 shows a perspective view of the piston rotor from the rotary engine of FIG. 1;

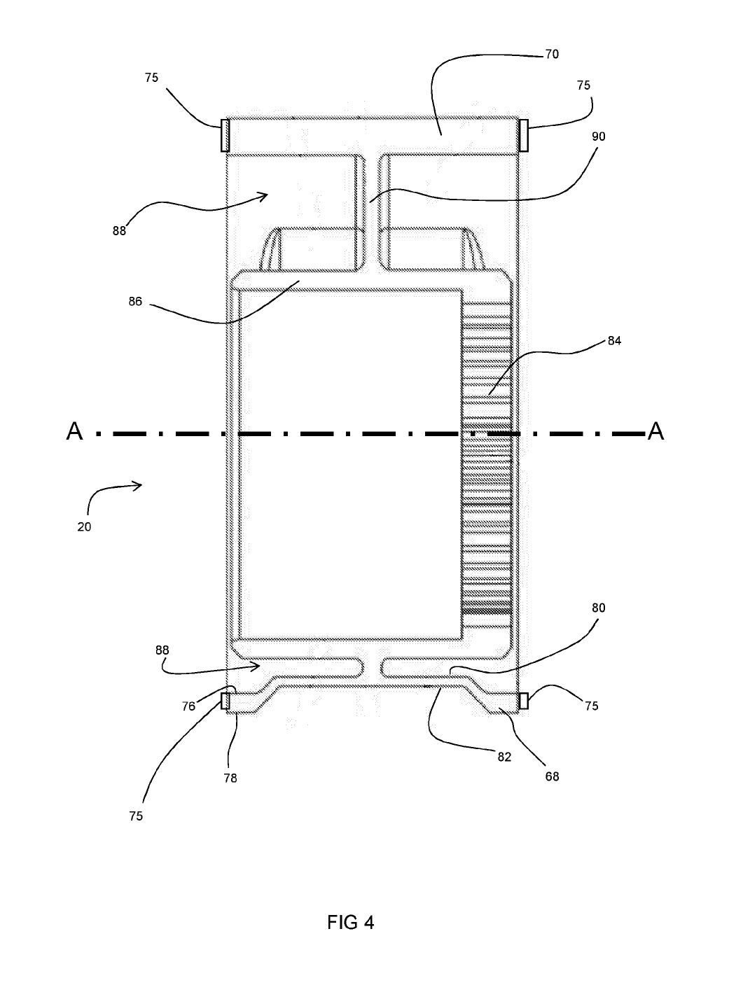

FIG. 4 shows a section view of the piston rotor of FIG. 3;

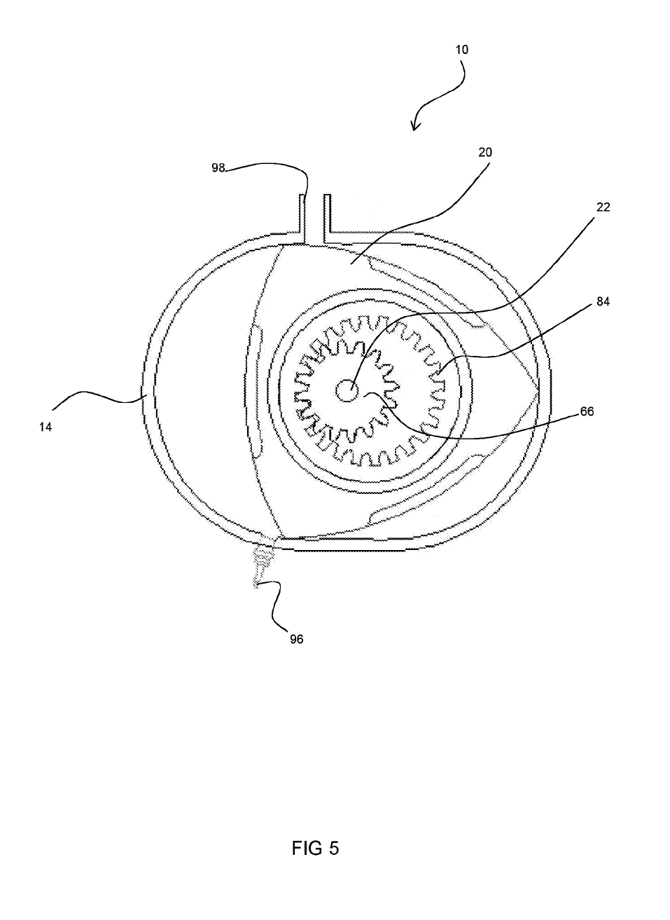

FIG. 5 shows a section view of the rotary engine of FIG. 1;

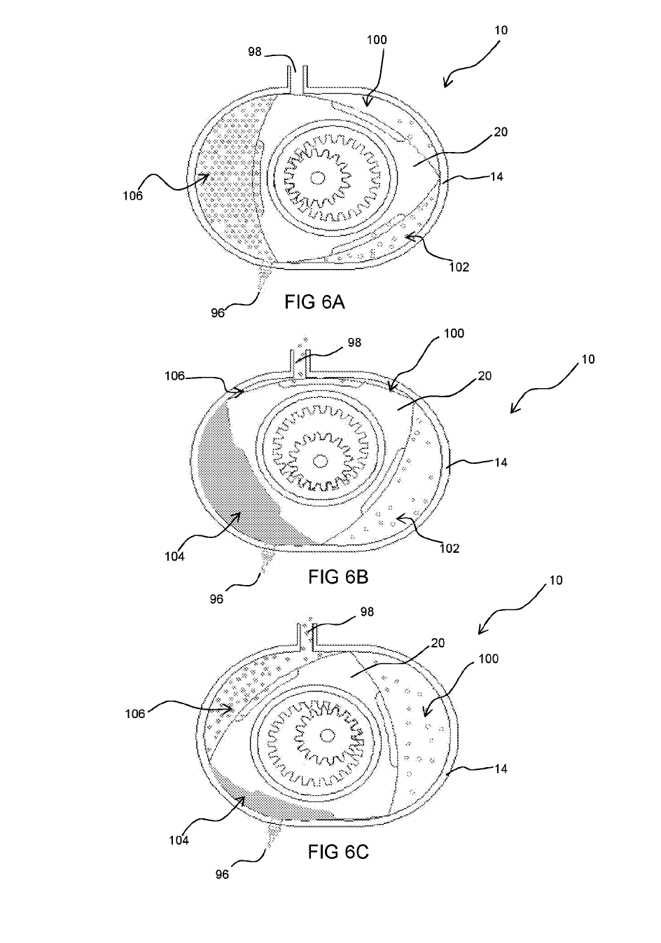

FIGS. 6A to C show similar views to FIG. 5 of the rotary engine during operation;

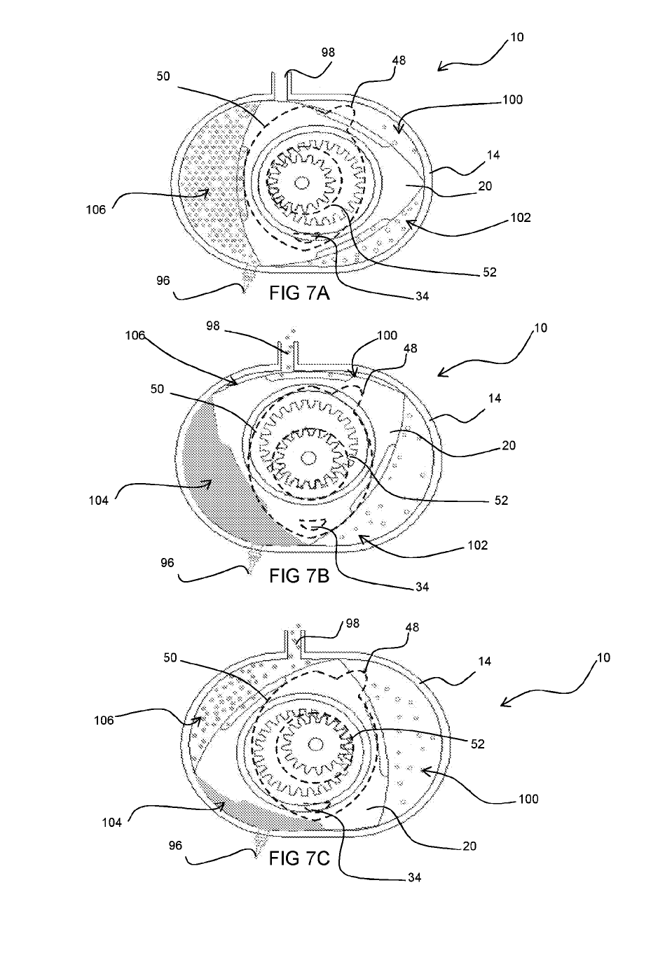

FIGS. 7A to C show similar views to FIGS. 6A to C with the addition of a channel;

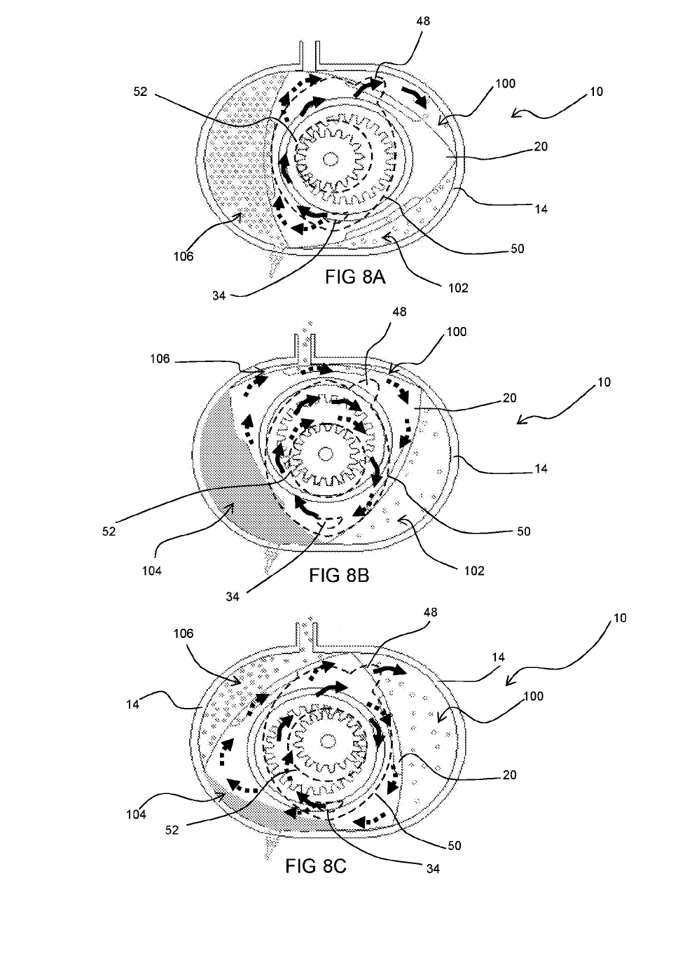

FIGS. 8A to C show similar schematics as FIGS. 7A to C together with charge air flows around the channel and rotor interior;

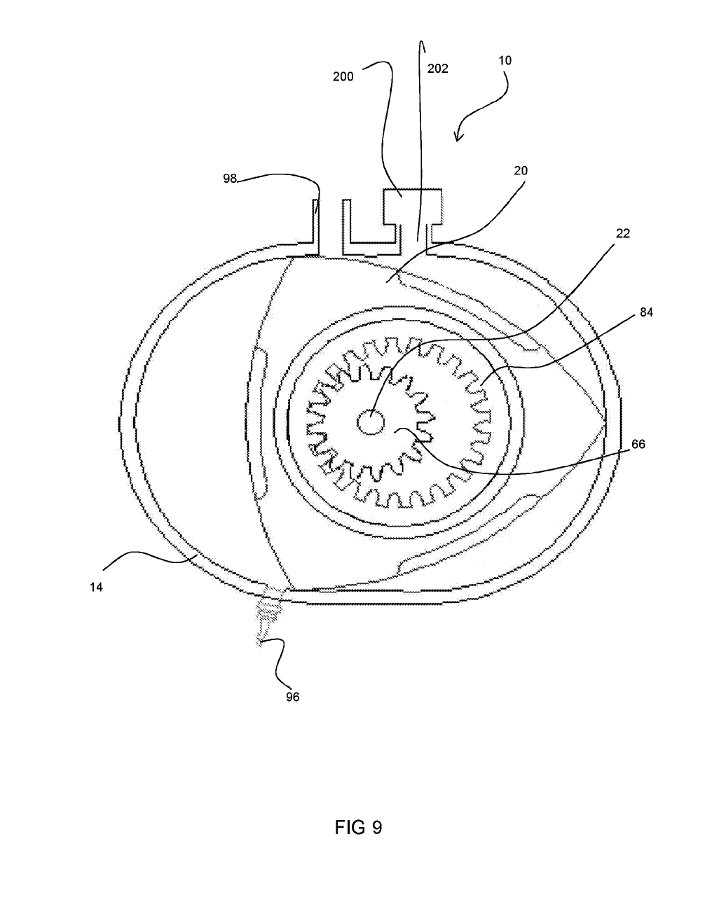

FIG. 9 shows a similar view as FIG. 5 of a second embodiment of the rotary engine;

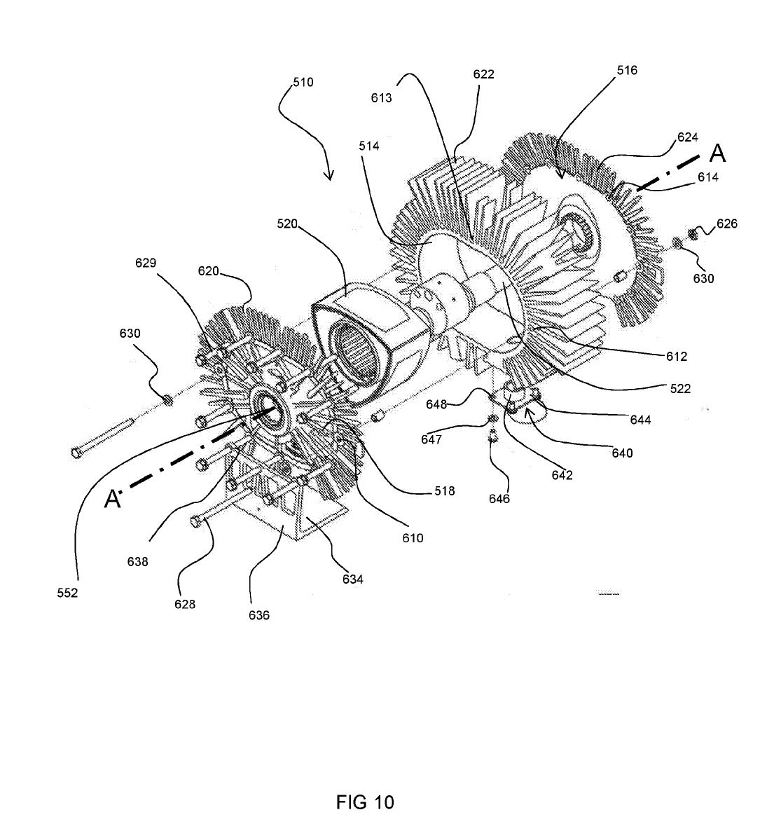

FIG. 10 shows an exploded view of a rotary engine according to another embodiment of the present invention; and

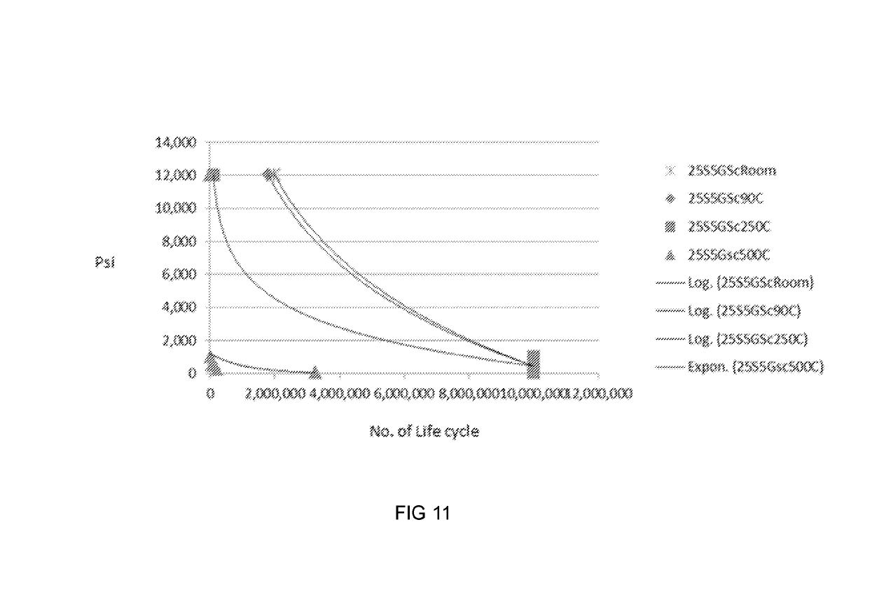

FIG. 11 shows fatigue life as a function of cyclic stress (i.e. S-N curve) for a MMC material according to an embodiment of the present invention.

With reference to FIGS. 1 to 5, a rotary engine 10 comprises a charge air inlet manifold 12, an epitrochoidal chamber housing 14 connected on either side to a first and second opposing side plates 16, 18 to form a housing assembly 19, and a rotor 20 contained within the housing assembly. The rotor 20 is meshed about an eccentric shaft 22, or e-shaft, which is rotatable about an axis (A).

The inlet manifold 12 comprises a bifurcated duct 24. The bifurcated duct 24 is substantially symmetrically arranged around the rotor housing assembly 19. The inlet manifold 12 comprises an inlet throat 26 suspended away from the rotary engine 10 by the bifurcated duct 24. The inlet manifold 12 is centrally located adjacent to the engine 10 so as to be in between the first and second side plates 16, 18. Each branch 28, 28′ of the bifurcated duct 24 comprises a manifold port flange 30, 30′. The manifold port flange 30, 30′ is welded to the exterior face 32 of the side plates 16, 18.

As shown in FIG. 2, the first side plate 16 comprises an inlet port 34 at the location where the manifold port flange 30 is connected. The inlet port 34 passes directly through the first side plate 16 so that the interior face 36 of the side plate and the inlet manifold 12 are in fluid communication. The first side plate 16 has two lobes 38a, 38b and two nodes 40a, 40b. The interior face 36 of the first side plate has an edge 41 defining an opening 42. The edge 41 is substantially oculiform having upper and lower apexes 44, 46. The edge 41 at the lower apex 46 of the opening extends radially outwards in comparison to the rest of the oculiform profile so as to form an exit port 48. The inlet port 34 is bounded by a substantially triangular shaped lip so as to fit close to the upper apex 44. Alternatively, the inlet port 34 may also be oculiform rotated 90° with respect to the oculiform opening 42.

The opening 42 leads to a channel 50 defined by a wall 51 arranged between the interior and exterior faces 36, 32. The wall 51 is substantially annular shaped beneath the interior surface 36. A shaft opening 52 is provided directly through the first side plate 16. The shaft opening 52 is centrally located within to the channel 50. The channel 50 is provided with a plurality of flow deflectors 54. The flow deflectors 54 are arcuate. The flow deflectors 54 extend generally radially outwards from the shaft opening 52. The flow deflectors 54 comprise ribs 56. The flow deflectors may also comprise grooves in combination with the ribs or as an alternative to the ribs. The ribs 56 and/or grooves of the flow deflectors 54 are continuous.

The shaft opening 52 is stepped having a seal race 58 and a diametrically larger bearing pocket 60. The bearing pocket 60 is sized to receive a shaft bearing 62. The seal race 58 is arranged to receive a shaft seal 64. When assembled, the eccentric shaft 22, the shaft seal 64 and the seal race 58 cooperate to hermetically seal the interior face 36 from the exterior face 32. The eccentric shaft 22 is journalled on the shaft bearing 62 received in the bearing pocket 60. The eccentric shaft 22 comprises a gear 66 arranged at the interior of the engine 10 when assembled.

The second side plate 18 also comprises a charge air inlet port 34, a charge air exit port 48 and a channel 50, all arranged to substantially form a mirror image of the charge air inlet port 34, the charge air exit port 48 and the channel 50 of the first side plate 16. Accordingly, like reference numerals are used when referring to those features of either side plate.

In FIG. 3, the rotor 20 is trilobal having three arcuate rotor faces 68 joined to adjacent faces at their ends so as to form three apices 70. The rotor 20 has an interior and an exterior divided by the faces 68. Each apex 70 comprises a slot 72 arranged to receive an apex seal 73. Each face 68 also comprises a substantially flat recess forming a combustion pocket 74. Each face 68 has a posterior combustion surface 76 and an anterior combustion surface 78. Likewise, the combustion pockets also have a posterior combustion surface 80 and an anterior combustion surface 82. The rotor faces 68 each have side seals 75 extending continuously around the entire rotor 20 (see FIG. 4).

The rotor 20 also has a phasing gear 84 arranged to mesh with the gear 66 of the eccentric shaft 22. The phasing gear 84 is arranged offset from the centre of the rotor 20. A bearing pocket wall 86 extends axially from the phasing gear 84 to the other side of the rotor 20. A central web 90 is provided which extends between the bearing pocket wall 86 and the posterior combustion surface 76 of the rotor faces (see FIG. 4). A charge air passage 88 is formed around the rotor 20 between the bearing pocket wall 86 and the posterior combustion surface 76 of each rotor face. The central web 90 thus forms two isolated charge air passages, one on either side of the rotor 20.

The rotor chamber housing 14 is connected to the first and second opposing side plates 16, 18 so as to form the rotor housing assembly 19. The rotor chamber 14 is epitrochoidal. Like the opposing side plates 16, 18, the rotor chamber housing 14 as two lobes 92a, 92b and two nodes 94a, 94b. The chamber housing 14 is arranged around the exterior of the rotor 20 such that the apex seals 73 are in contact with the inner face of the chamber housing 14. A spark plug 96 is provided through the rotor chamber housing 14. The spark plug 96 is angularly separated from the exit ports 48 by approximately 180°. The angle may be anywhere between 120 and 240°. An exhaust port 98 is provided on the rotor chamber housing 14.

When assembled, the phasing gear 84 of the rotor 20 is meshed with the gear 66 of the eccentric shaft 22.

With reference to FIGS. 6A to C, the apex seals are arranged to engage with the inner faces of the rotor chamber housing 14 so as to form a hermetic seal. The rotor interior is hermetically sealed from the rotor chamber housing by the side seals 75 and the interior faces 36 of the first and second side plates 16, 18 being in continuous contact. Rotation of the rotor 20 around the epitrochoidal chamber housing 14 forms four varying volume segments. Those segments include an intake segment 100, a compression segment 102, a combustion segment 104, and an exhaust segment 106. Those four segments and three apices give rise to a Wankel combustion cycle which is described in more detail below.

Charge air is defined as ambient air directed to the engine 10 for combustion. Charge air is mixed with fuel vapour upstream of the inlet throat 26 in a conventional manner using a carburettor. The carburettor itself is conventional and so is not described in detail here. Approximately equal amounts of charge air are directed down each branch 28, 28′ side of the bifurcated duct 24.

With reference to FIGS. 7A to C, and FIGS. 8A to C, charge air passes through the manifold port flange 30, 30′ into the channel 50 through the charge air inlet port 34. The charge air inlet ports 34 are thus arranged to direct charge air to the interior of the rotor 20. The charge air remains at this stage at the interior of the rotor 20. The oculiform edge 41 of opening 42 ensures that this is the case since the edge 41 corresponds to the boundary limit of rotor 20 coverage during complete revolution. At no time during rotation does the rotor 20 move to a position where the oculiform opening is not bounded by the side seals 75. The oculiform shape provides an opening of maximum achievable surface area in view of the three face rotor.

Rotation of the rotor 20 cooperates with the channel 50 to cause the charge air to disperse radially by virtue of the induced centrifugal motion. Charge air escaping from the channel 50 is forced against the posterior combustion surfaces 76, 80 of each face 68 and combustion pocket 74. The charge air draws heat away from the posterior combustion surfaces 76, 80 thus reducing the temperature of the rotor faces 68. More heat is extracted from the rotor 20 in this way than by passing charge air from one side of the rotor to the other since an increase surface area of the rotor 20 is exposed and for a longer period of time. The fuel vapour in the charge air evaporates and the fuel atomises drawing further heat in turn due to the latent heat of vaporisation. Charge air circulates around the interior of the rotor 20 in the charge air passage 88. Charge air which impinges the radial web 90 is further encouraged to disperse radially against the posterior combustion surfaces 76, 80. The two charge air inlet ports 34 and the radial web 90 cooperate to provide two distinct but symmetrical charge air flow paths at the rotor interior. This results in balanced cooling of the rotor faces 68.

It should be noted that the eccentric shaft 22 is not isolated from the charge air passage 88. Charge air escaping from the channel 50 is therefore able to surround the eccentric shaft 22 also leading to cooling of the interface between the phasing gear 84 and the gear 66 of the eccentric shaft 22.

As the rotor 20 rotates, the rotor faces 68 intermittently expose the exit ports 48 depending on the rotational position of the rotor 20. The exit ports 48 are located in the intake segment of the chamber housing 14 when exposed. When exposed, the exit ports 48 exhaust a quantity of charge air directly into the intake segment 100 of the chamber housing 14. The charge air is moved to the compression segment 102 by the rotation of the rotor 20. The compression segment 102 of the chamber housing 14 decreases in volume as the rotor 20 rotates. In turn, charge air moves from the compression segment 102 to the combustion segment 104 when the apex seal 73 is about 17° before reaching the spark plug 96. The spark plug 96 is arranged to ignite the compressed charge air in the combustion segment 102. The combustion of the charge air forces the rotor 20 to rotate around the chamber housing 14 which induces a rotation in the eccentric shaft 22. The combustion is enhanced by the atomised fuel in the charge air resulting from the cooling process and the interior of the rotor 20. The combustion segment 104 increases in volume and transitions to the exhaust segment 106 when the apex seal passes the exhaust port 98. Continued rotation of the rotor 20 reduces the volume of the exhaust segment 106 causing the exhaust gases to exhaust out of the rotor chamber housing assembly through the exhaust port 98. The Wankel combustion cycle continues with successive rotor faces 68 traversing through the variable volume segments of the rotor chamber housing 14.

A metal matrix composite material is used for fabricating some of the engine 10 components. The metal matrix composite (MMC) comprises 11% (wt) silicon carbide, 5 to 7.5% (wt) nickel coated graphite, 0.2 to 3% (wt) magnesium, and a balance of aluminium. The actual quantity of silicon carbide is preferably within the range from 15 to 30% (wt). It can be an even larger range for example from 10 to 35% (wt) however above 30% (wt) the material becomes more difficult to mold and there are diminishing returns for the improvements in lubriciousness. Also, the nickel coated graphite range can be increased from 1 to 10% (wt). However, the increased cost of more nickel coated graphite coupled with the diminishing returns of improved lubriciousness mean that 7.5% (wt) is a preferable maximum. The engine components which comprise the MMC material include the rotor chamber housing assembly 14 or housing assembly 19. The MMC with the inclusion of 0.2% (wt) Scandium is also used for fabricating the eccentric shaft 22. The actual quantity of Scandium may be between 0.18% (wt) and 0.22% (wt). The rotor 20 also comprises the MMC material with the addition of 0.9 to 20% (wt) elemental silicon. The apex seals 73 are made from a ceramic material. The side seals 75 are made from gray metal. The MMC material has a Rockwell Hardness of between 80 and 81. By way of comparison, other shafts are typically made from an alloy such as AN24T which has a hardness three times that of mild steel and which corresponds to a Rockwell Harness of approximately 43. Therefore, those components made from the MMC material have much improved durability in comparison.

Another reason for using the MMC material for those components is because of the self lubricating properties that it provides. The MMC material lubricates the friction surfaces of each of those components. Friction surfaces exist between the apex seals 73 and the rotor chamber housing 14, the meshed interface between the eccentric shaft 22 and the rotor 20, and the side seals 75 and the interior faces 36 of the first and second side plates.

The nickel coated graphite and the silicon carbide in the MMC material provide self lubricating properties at each of those interfaces over the full operating temperature range experienced by an engine 10. This temperature range is from about −40° C. to a temperature at which material deformation occurs. The nickel coated graphite exhibits lubricious properties at the lower end of the temperature range between about −40° C. and 100° C. The silicon carbide exhibits lubricious properties at the higher end of the temperature range between about 85° C. to material deformation temperature. In fact, the silicon carbide in the aforementioned range continues to provide improved lubriciousness with increasing temperature, even above the temperature at which material deformation occurs.

The lower aforementioned temperature range, which relies on the lubriciousness of the nickel coated graphite, is experienced at engine start up and when ambient air contacts those portions of the engine along the inlet path during the combustion cycle. Particularly, the intake segment 100 of the chamber housing 14 and the rotor faces 68 while in the intake segment. In fact, since the interior of the rotor 20 is part of the inlet path, the entire rotor 20 is exposed to the lower temperature charge air. This also includes the eccentric shaft 22 which is fluidly exposed to the rotor interior. Low temperatures for ambient air are common in aviation.

The higher aforementioned temperature range is experienced during combustion of the charge air. Those components experiencing the higher temperature range are the combustion segment 104 of the chamber housing 14 and the rotor faces 68 while in the combustion segment.

The rotor faces 68 experience rapid changes in temperature between the intake segment 100 and the combustion segment 104. The addition of silicon in the aforementioned range improves the thermal conductivity of the rotor approaching that of tempered steel as opposed to pure aluminium. A thermal conductivity in this range improves resistance to thermal fatigue and therefore prolongs the life of the rotor 20. Also, the risk of the hermetic seal between the apex seal and the rotor chamber housing 14 being broken as a result of thermal expansion and contraction of the rotor 20 is reduced. Although possible, it is less important to include elemental silicon in the MMC material for the components other than the rotor 20 since those other components do not experience such rapid temperature changes.

The addition of magnesium in the aforementioned range is optional. However it is advantageous to add magnesium since it improves the cohesiveness of the elements of the mixture and adds strength. The actual quantity of magnesium depends on the quantity of silicon carbide in the mix.

The aforementioned MMC can be used also to fabricate components of non rotary engines, such as pistons where lubricating properties are also important.

With reference to FIG. 10, a second embodiment of the rotary engine 10 is described below. Those features in common with the first embodiment share like reference numerals.

The rotary engine 10 according to the second embodiment includes a fuel injection system 200. The fuel injection system 200 is of conventional form and is not described in detail here. The fuel injection system 200 is coupled to an intake passage 202 arranged to direct fuel at a predetermined amount to the intake segment 100 of the chamber housing 14. The second embodiment therefore differs from the first embodiment in that the charge air flowing through the interior of the rotor 20 for cooling the rotor faces 68 does not comprise fuel vapour. Injecting the fuel directly to the chamber housing 14 after the charge air has entered it decreases the benefit of the latent heat of vaporisation but provides a higher degree of control over the quantity, timing and location of injection of the fuel into the chamber housing 14.

With reference to FIG. 10 another embodiment of a rotary engine 510 is provided. A detailed description of those features in common with the first embodiment is not repeated. Common features are numbered 500 greater than the first embodiment.

The first and second side plates 516, 518 each have 12 through holes 610, 614. The chamber housing 514 has a set of ten internally threaded holes 612 on each of the first and second sides. The chamber housing 514 also has two through holes 613 alignable with two of the through holes on each of the first and second side plates 516, 518. Each of the first and second side plates 516, 518 and the chamber housing 514 are provided with a plurality of protrusions 620, 622, 624 collectively forming a heat sink. Two relatively long bolts 628 are provided together with four washers 630 and two nuts 626. The long bolts 628 are arranged to pass through the through holes of the first side plate 516, the chamber housing 514 and the second side plate 518 so as to form a guide for quickly installing the second side plate 518. Twenty relatively short bolts 629 are provided, ten for securing the first side plate 516 to the rotor chamber housing 514, and ten for securing the second side plate 518 to the rotor chamber housing 514.

An engine support 634 is provided to mount the engine 510 to a vehicle. The engine support 634 is a right angle section having an upstanding arm 636 provided with three through holes 638 for receiving three of the relatively short bolts 629. The three relatively short bolts 629 secure the engine support to the second side plate 518 side to the engine support 634.

An exhaust duct 640 is provided for securing to the exhaust port 598 of the chamber housing 514 for exhausting exhaust gases therethrough. The exhaust duct 640 comprises a conduit portion 642 and a flange portion 644. The flange portion 644 is generally square shaped. Four bolts 646, one at each corner of the flange portion 644, are provided through through-holes 648 of the flange portion 644. The four bolts 646 and washers 647 secure the exhaust duct 640 to an exhaust passage (not shown) for exhausting the exhaust gases overboard of the vehicle.

During installation, the first side plate 516 is mounted over the eccentric shaft 522. The rotor chamber housing 514 is then mounted over the eccentric shaft 522. Ten relatively short bolts 629 are threaded through ten of the through holes 614 and the ten internally threaded holes 613 of the first side plate 516 and the rotor chamber housing 514 respectively so as to secure the first side plate 516 to the rotor chamber housing 514 on a first side of the rotor chamber housing 514. The rotor 520 is then installed onto the eccentric shaft 522 inside the rotor chamber housing 514. The second side plate 518 is place adjacent to the second side of the rotor chamber housing 514. The eccentric shaft 522 penetrates the shaft opening 552 of the second side plate 518. The two relatively long bolts 628 are passed through the respective through holes 610, 613, 614 of the second side plate 518, rotor chamber housing 514, and then the first side plate 516 so as to align all of the remaining through holes 610 of the second side plate 518 with the internally threaded holes 612 on the second side of the rotor chamber housing 514. The ten remaining relatively short bolts 629 are passed through the through holes of the second side plate 514 to threadingly engage the internally threaded holes 612 on the second side of the rotor chamber housing 514 so as to secure the two engine components together.

When maintenance or servicing of the rotor 520 is required during the operational life of the engine 510, the second side plate 518 can be removed without the need for dismantling the entire housing assembly 519 nor removal of the rotor chamber housing 514 or the first side plate 516 from the eccentric shaft 522. The ten relatively short bolts 629 are removed followed by the two relatively long bolts 628. The second side plate 528 can thus be removed from the second side of the rotor chamber housing 514 allowing access to the interior of the rotor chamber housing 514 for removal and subsequent installation of the rotor 520 about the eccentric shaft 522 as a modular unit. The two relatively long bolts 628 are passed through the relevant through holes 610, 613, 614 of the second side plate 518, rotor chamber housing 514, and the first side plate 516 respectively so as to act as a guide for aligning the remaining through holes 610 of the second side plate 518 with the internally threaded holes 613 of the second side of the rotor chamber housing 514. The ten relatively short bolts 629 can be used to secure the second side plate 518 to the second side of the rotor chamber housing 514 as described hereinabove. A counter balance (not shown) may be placed on the external face of the second side plate 518.

The materials of the engine components of the rotary engine 510 of the second embodiment are the same as those of the first embodiment. Namely, the rotor chamber housing 514 is made from the MMC comprising 10 to 35% (wt) silicon carbide, 1 to 10% (wt) nickel coated graphite, 0.2 to 3% (wt) magnesium, and a balance of aluminium. The eccentric shaft 522 is also made from the MMC with the addition of Scandium between 0.18% (wt) and 0.22% (wt), preferably 0.2% (wt). The rotor 520 also comprises the MMC material with the addition of 9 to 20% (wt) elemental silicon. The apex seals 573 are made from a ceramic material. The side seals 575 are made from gray metal. Similar caveats apply to the permutations of constituent material quantities to those stated above for the rotary engine 10 of the first embodiment.

The rotary engine 510 of the second embodiment also comprises an air cooling system being substantially the same as the air cooling system of the rotary engine 10 of either the first or second embodiments. Namely, each side plate 516, 518 has a mirror imaged arrangement of an air inlet 534, an oculiform edge 541 defining an opening 542 having an exit port 548 leading directly to the rotor chamber housing assembly 514.

In an alternative arrangement, another guide may be employed for example an indexing arrangement.

By virtue of the described arrangement of the rotary engine, the rotor housing and/or the e-shaft can be configured to remain attached to the second side plate on removal of the first side plate.

In all embodiments the inlet and outlet ports can, as illustrated in the drawings and as described in the above, be arranged to be angularly separated at various angles relative to one another. They are angularly separated on the side plates, at the stated angles about the axis of rotation of the eccentric shaft or e-shaft 22 or 522, about which the rotor 20 or 520 is meshed. They can be angularly separated by any value within the ranges of angles stated, at or between the stated upper and lower limits. This arrangement acts to locate the inlet and outlet ports at substantially opposite sides of the eccentric shaft, or e-shaft, to encourage charge air from the inlet port to flow around the rotor and thus improve the cooling effect of the charge air on the rotor.

In an aspect of the present invention, there is provided a Metal Matrix Composite (MMC) material for an engine component, comprising: 10-35 wt % silicon carbide; 1-15 wt % nickel coated graphite; optionally 0.2-3 wt % magnesium; optionally 0-20 wt % silicon; and the remaining wt % being an aluminium-based matrix and unavoidable impurities, wherein the aluminium-based matrix comprises: 10-35 wt % silicon carbide; optionally 0-20 wt % silicon; optionally 0.18-0.22 wt % scandium; optionally 0-5 wt % of a flow enhancer; and the remaining wt % being an aluminium-based alloy and unavoidable impurities.

The MMC of this aspect may include any features of the MMC described in relation to the earlier embodiments.

Suitable aluminium-based alloys are commercially available. Useful series of aluminium alloys include 300 (e.g. A319.1 aluminium alloy, A354.1 aluminium alloy, A355, A355.2 aluminium alloy, A356 aluminium alloy, D356 aluminium alloy, A356.1 aluminium alloy, A357 aluminium alloy, D357 aluminium alloy and AA359) (obtained from Eck Industries, USA or Duralcan, Canada). Other examples of suitable aluminium alloys include LM13, LM14, LM15, LM16, LM17, LM18, LM19, LM20, A206 and A242 (obtained from Eck Industries, USA or Duralcan, Canada). For example, the aluminium-based alloy may be selected from any one of AA356, AA359, LM-13, LM14, LM15, LM16, LM17, LM18, LM19 and LM20, preferably AA356, AA359 and LM-20. In an embodiment of the invention, the aluminium-based alloy is commercially available AA359 alloy with the chemical composition shown in Table 1.

TABLE 1
Chemical composition limits (weight %): aluminium AA359

| Al | Cu | Fe | Mg | Mn | Si | Ti | Zn |
|---|---|---|---|---|---|---|---|
| 88.8-91 | <=0.20 | <=0.20 | 0.50-0.70 | <=0.10 | 8.95-9.5 | <=0.20 | <=0.10 |

In another embodiment of the invention, the aluminium-based alloy is commercially available AA356 alloy with the chemical composition shown in Table 2.

TABLE 2
Chemical composition limits (weight %): aluminium AA356

| Al | Cu | Fe | Mg | Mn | Si | Ti | Zn |
|---|---|---|---|---|---|---|---|
| 90.2-93.3 | <=0.25 | <=0.50 | 0.25-0.45 | <=0.35 | 6.5-7.5 | <=0.25 | <=0.35 |

In a further embodiment, the aluminium-based alloy is commercially available LM20 with the chemical composition shown in Table 3.

TABLE 3
Chemical composition limits (weight %): aluminium LM20

| Al | Cu | Fe | Mg | Mn | Si | Ti | Zn | Ni | Pb |
|---|---|---|---|---|---|---|---|---|---|
| Balance | <=0.4 | <=1.0 | 0.2 | <=0.5 | 10.0-13.0 | <=0.2 | <=0.2 | 0.1 | 0.1 |

To create the MMC of the invention, alloying elements are added to the aluminium-based alloy to create a modified base alloy (i.e. the aluminium-based matrix) before further components are added at the MMC level.

The aluminium-based matrix of the present invention comprises a commercially available aluminium-based alloy (e.g. AA359, AA356, LM20 etc.) which has been modified with other alloying elements. Suitable alloying elements include SiC, Si, Al₂O₃, iron, cast iron, scandium and combinations thereof.

In an embodiment of the invention, the aluminium-based matrix of the present invention is a commercially available aluminium alloy (such as those defined above) which has been modified with up to 30 weight % of SiC, preferably 20 to 30 weight % SiC. In an embodiment of the invention, the aluminium-based matrix also comprises 0.18-0.22 wt % scandium, 0-20 wt % silicon, preferably 9-20 wt % silicon, and/or 0-5 wt % of a flow enhancer. In an embodiment of the invention, the aluminium-based matrix of the present invention comprises AA359, AA356 or LM20 and 25 weight % (of the aluminium-based matrix) of SiC.

The aluminium-based matrix of the present invention may also comprise a flow enhancer. In the context of the present invention, the term “flow enhancer” refers to compounds that are capable of improving the rheology, e.g. the flowability, of the molten metal matrix composite material, such that the material has favourable properties for introduction into a casting mould. The flow enhancer may be iron, preferably cast iron.

The amount of flow enhancer used in the aluminium-based matrix of the present invention may be from 0 to 5 wt %, preferably from 2 to 3 wt %. In an embodiment of the invention, the aluminium-based alloy is modified with 2-3 wt. % cast iron.

Once the modified alloy/aluminium-based matrix has been formed with standard alloying techniques, further components (such as, additional silicon/silicon carbide, magnesium and nickel coated graphite particles) may be added at the MMC level, by mixing them into the molten alloy in the defined manner.

The MMC material of the present invention comprises nickel coated graphite particles. Techniques for depositing nickel on the graphite particles are known in the art and include electroplating and vacuum deposition techniques. Nickel coated graphite particles used in the present invention are obtained from Eck Industries USA.

In the metal matrix composite of the present invention, the amount of silicon carbide is from 10 to 35 wt %, preferably from 15 to 30 wt %, more preferably from 22 to 28 wt %. The amount of silicon carbide will depend on the size of the piston/rotors and the material used for the cylinder wall, sleeve, end plate, rotor housing etc. as one needs to take into consideration thermal expansion of a piston/rotor in comparison to that of its surrounding components, such as cylinder walls, cylinder sleeves, an engine block, or rotor housings etc. Therefore the amount of silicon carbide used in a first component can be selected to cause the coefficient of thermal expansion of the first component to match the coefficient of thermal expansion of a second component, with which the first component mates or engages, or within which the first component is received.

As discussed above, the aluminium-based matrix of the present invention comprises from 10 to 35 wt % of silicon carbide, preferably from 15 to 30 wt %, more preferably from 22 to 28 wt %.

The amount of silicon used in the metal matrix composite of the present invention may be from 0 to 20 wt %, or from 9 to 20 wt %, or from 11 to 17 wt %, or from 9 to 15 wt %. As detailed above, silicon may be added to the metal matrix composite in both the aluminium-based matrix and at the MMC level (as a further component). When the MMC material is cast, such as by high pressure die casting, around 50-100 wt % of the silicon contained in the metal matrix composite material is converted to silicon carbide.

The one or more engine components of the present invention may be a shaft. In an embodiment of the present invention, the shaft is an eccentric shaft or a crank shaft. When the one or more engine components of the present invention is an eccentric shaft or a crank shaft, the aluminium-based matrix of the metal matrix composite may comprise from 0.18 to 0.22 wt % scandium.

The MMC described herein has also been found to be advantageous when used to fabricate the following further components for non-rotary engines: cylinder liners, cylinder heads, cylinder blocks, engine manifolds, crank shafts, cam shafts, drive shafts and valves.

The preferred composition for cylinder liners is an MMC material, comprising: 25 wt % silicon; 5 wt % nickel coated graphite and the remaining wt % being an aluminium-based matrix, wherein the aluminium-based matrix comprises 25 wt % silicon and the remaining wt % being a commercially available aluminium alloy (such as those detailed above). The MMC material is then cast, optionally with inserts, where necessary to obtain the appropriate physical form of the component, using conventional techniques known in the art.

The material is particularly suited to use in cylinder liners because it provides excellent thermal conductivity as well as lubriciousness during operation. The nickel coated graphite also provides lubriciousness during colder operation at relatively low operating temperatures. In addition, the hardness of the material provides a good quality surface exhibiting the required smoothness without the need for further treatments. For example, only final finish grinding, honing and/or polishing is needed. In contrast, conventional cylinder liners require additional material treatments, such as, coating the material with PTFE or NiSil, an alloy of Nickel and Silicon.

The preferred composition for a cylinder head is an MMC material comprising: 25 wt % silicon; 5 wt % nickel coated graphite and the remaining wt % being an aluminium-based matrix, wherein the aluminium-based matrix comprises 25 wt % silicon and the remaining wt % being a commercially available aluminium alloy (such as those detailed above). The MMC material is then cast, optionally with inserts, where necessary to obtain the appropriate physical form of the component, using techniques known in the art.

The material is particularly suited to use in a cylinder head because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed.

The preferred composition for a cylinder block is an MMC material comprising: 25 wt % silicon; 5 wt % nickel coated graphite and the remaining wt % being an aluminium-based matrix, wherein the aluminium-based matrix comprises 25 wt % silicon and the remaining wt % being a commercially available aluminium alloy (such as those detailed above). The MMC material is then cast, optionally with inserts to obtain the required form of the component, using techniques known in the art.

The material is particularly suited to use in a cylinder block for an engine because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed.

The preferred composition for an engine manifold is an MMC comprising: 25 wt % silicon; 5 wt % nickel coated graphite and the remaining wt % being an aluminium-based matrix, wherein the aluminium-based matrix comprises 25 wt % silicon and the remaining wt % being a commercially available aluminium alloy (such as those detailed above). The MMC material is then cast, optionally with inserts to obtain the required form of the component, using techniques known in the art.

The material is particularly suited to use in an engine manifold because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed.

The preferred composition for a crank shaft is an MMC comprising: 25 wt % silicon; 5 wt % nickel coated graphite and the remaining wt % being an aluminium-based matrix, wherein the aluminium-based matrix comprises 25 wt % silicon, 2 wt % scandium and 2 to 3 wt % cast iron and the remaining balance being a commercially available aluminium alloy (such as those detailed above). The MMC material is then cast, optionally with inserts, using techniques known in the art.

The material is particularly suited to use in a crank shaft because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed.

The preferred composition for a cam shaft is an MMC comprising: 25 wt % silicon; 5 wt % nickel coated graphite and the remaining wt % being an aluminium-based matrix, wherein the aluminium-based matrix comprises 25 wt. % silicon, 2 et % scandium, 2 to 3 wt. % cast iron and the remaining balance being a commercially available aluminium alloy (such as those detailed above). The MMC material is then cast, optionally with inserts where necessary to obtain the appropriate physical form of the component, using techniques known in the art.

The material is particularly suited to use in a cam shaft because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed. Moreover, the addition of scandium to the MMC material results in a material having improved life expectancy and fatigue life, such that the material has characteristics of other multi-hardened materials but at a lower weight, greater hardness and greater lubriciousness than conventional materials.

The preferred composition for a drive shaft is an MMC comprising: 25 wt % silicon; 5 wt % nickel coated graphite and the remaining wt % being an aluminium-based matrix, wherein the aluminium-based matrix comprises 25 wt. % silicon, 2 wt. % scandium and the remaining balance being a commercially available aluminium alloy (such as those detailed above). The MMC material is then cast, optionally with inserts, where necessary to obtain the appropriate physical form of the component, using techniques known in the art.

The material is particularly suited to use in a drive shaft because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed. Moreover, the addition of scandium to the MMC material results in a material having improved life expectancy and fatigue, such that the material has characteristics of other multi-hardened materials but at a lower weight, greater hardness and lubriciousness than conventional materials.

The preferred composition for an engine valve is an MMC comprising: 25 wt % silicon; 5 wt % nickel coated graphite and the remaining wt % being an aluminium-based matrix, wherein the aluminium-based matrix comprises 25 wt. % silicon, 2 wt. % scandium and the remaining balance being a commercially available aluminium alloy (such as those detailed above). The MMC material is then cast, optionally with inserts, using techniques known in the art.

The material is particularly suited to use in an engine valve because it provides excellent thermal conductivity as well as lubriciousness during operations. The nickel coated graphite also provides lubriciousness during colder operations. In addition, the hardness of the material provides a good quality surface without the need for further treatments. For example, only final finish grinding, honing and/or polishing is needed. Moreover, the addition of scandium to the MMC material results in a material having improved life expectancy and fatigue, such that the material has characteristics of other multi-hardened materials but at a lower weight, greater hardness and lubriciousness than conventional materials.

### Method of Making MMC Material of the Present Invention

A base alloy of commercially available AA359 (obtained from Eck Industries, USA or Duralcan, Canada), having the composition defined in Table 1, is melted to a liquid state before being premixed with silicon (or silicon carbide) by conventional pre-mixing processes. Additional materials (such as, silicon (or silicon carbide) and nickel coated graphite particles (i.e. the MMC mixture)) are floated in the molten mixture. The mixture is then stirred using a graphite impeller until homogenous. The material is then left to harden. Once hardened, the ingot is melted and cast. Once the casting process is complete, the top or outer layer of the resulting MMC material is cleaned off by grinding and/or polishing, such that the MMC mixture is exposed at the surface of the material.

Method of Making an Engine Component from the MMC Material of the Present Invention

Metal matrix composite articles according to the present invention can be cast, optionally with inserts to obtain the required form of the component, using techniques known in the art (e.g. gravity casting, die casting and squeeze casting).

### Fatigue Tests

High-cycle fatigue tests were carried out for a MMC material according to the present invention. Results from these fatigue tests are presented in FIG. 11 in the form of an S-N curve.

The fatigue specimens were tested in accordance with ASTM specification E716 standard, for spectrochemical analysis for alloys. The fatigue testing was done with 28 ingots of an MMC according to the present invention at ambient, 90, 120, 250, 400 and 500° C. The tests were carried out in accordance with engineering standards. Further R=−1 fatigue testing at 250° C. and 400° C., at stress levels up to 8,000 PSI, were also carried out. As demonstrated in FIG. 11, there were no failures at either temperature or any stress levels below 8,000 PSI at less than 10,000,000 cycles.

1-64. (canceled)

65. A Metal Matrix Composite (MMC) material for an engine component, comprising aluminium-based matrix of an aluminium-based alloy and unavoidable impurities and the matrix including 10 to 35% by weight silicon carbide and wherein the composite includes 1 to 15% by weight of nickel coated graphite.

66. The MMC material of claim 65, wherein the quantity of silicon carbide in the aluminium-based matrix is 15 to 30% by weight thereof.

67. The MMC material of claim 65, wherein the quantity of nickel coated graphite in the matrix is 1 to 10% by weight thereof.

68. The MMC material of claim 65 wherein the quantity of nickel coated graphite is 5 to 7.5% by weight thereof.

69. The MMC material of claim 65 further comprising 0.2 to 3% by weight magnesium.

70. The MMC material of claim 65 further comprising 0.18 to 0.22% by weight scandium.

71. The MMC material of claim 65 further comprising iron as a flow enhancer.

72. The MMC material of claim 71 wherein the iron is cast iron.

73. The MMC material of claim 71 wherein the amount of flow enhancer is not greater than 5% by weight of the composite.

74. The MMC material of claim 65, wherein the matrix includes silicon in an amount of 9 to 20% by weight thereof.

75. The MMC material of claim 74, wherein the amount of silicon in the matrix is 9 to 15% by weight thereof.

76. The MMC material of claim 74 wherein the engine component is a rotary engine rotor.

77. The MMC material of claim 70 wherein the engine component is a rotary engine shaft.

78. The MMC material of claim 70 wherein the engine component is a rotary engine rotor chamber housing or housing assembly.

79. The MMC material of claim 65 wherein the engine component is a rotary engine component selected from the list of a rotary engine rotor chamber housing or housing assembly, a rotary engine rotor, a piston, a side plate, a shaft, a cylinder liner, a cylinder head, a cylinder block, an engine manifold, a crank shaft, a cam shaft, a drive shaft, an eccentric shaft of a rotary engine and a valve.
